(19) United States
(12) Patent Application Publication
(10) Pub. No.: US 2015/0153473 A1
(43) Pub. Date: Jun. 4, 2015

(54) SYSTEM AND METHOD FOR GEOPHYSICAL SURVEYING USING ELECTROMAGNETIC FIELDS AND GRADIENTS

(71) Applicant: FUGRO CANADA CORP., Mississauga (CA)

(72) Inventors: Richard Stuart Smith, Ottawa (CA); Alexander Peter Annan, Mississauga (CA)

(21) Appl. No.: 14/386,192

(22) PCT Filed: Mar. 19, 2013
(86) PCT No.: PCT/CA2013/000264

§ 371 Date: Sep. 18, 2014

Related U.S. Application Data
(60) Provisional application No. 61/614,691, filed on Mar. 23, 2012.

(51) Int. Cl. G01V 3/38; G01V 3/165

(52) U.S. Cl. CPC G01V 3/38; G01V 3/165

(57) ABSTRACT

Electromagnetic exploration methods are used to identify a subsurface anomalous feature. This is sometimes difficult in the presence of large fields from the transmitter or other surrounding material that may be above and around the subsurface feature. By constructing linear combinations of the field and gradients of the field it is possible to remove the large fields associated with the transmitter and the surrounding material to make identification of the anomalous subsurface material easier. The fields and gradients can also be combined so as to provide estimates of other electromagnetic field quantities that would be otherwise difficult to measure, for example the electric field or the time derivative of the electric field.

### FIELD OF THE INVENTION

The present invention relates to geological surveying, and more particularly, to systems and methods for conducting geophysical surveys using electromagnetic fields and gradients.

### BACKGROUND OF THE INVENTION

Electromagnetic (EM) measurement systems for geophysical measurement purposes, generally detect the electric and magnetic fields that can be measured in, on or above the earth, in order to identify subsurface changes in electrical properties of materials beneath the earth's surface. Airborne EM systems carry out the field measurements in the air above the earth. A primary goal is to make measurements at a number of spatial locations to identify the size and position of localized material property changes. Such changes can be attributed to a desired outcome such as identifying a localized mineral deposit, a buried object, or the presence or absence of water. The measurements can be made at a range of excitation frequencies (frequency domain) or at various times during or after a transient excitation pulse (time domain).

Generally speaking, EM systems usually include a source of electromagnetic energy (transmitter) and a receiver to detect the response of the ground. The transmitter of an EM system generates a primary electromagnetic field. This primary electromagnetic field induces electrical currents in the ground, and the secondary electromagnetic field produced by these currents is measured to provide information regarding ground conductivity distributions. By processing and interpreting the received signals, it is possible to make deductions about the distribution of anomalous conductivity in the subsurface.

Currently, existing EM systems have had limitations when used to identify conductive targets that are embedded in a conductive background material. In such cases, the response associated with the background material can be significantly greater than the response of the targets, making it difficult to recognize or characterize the targets in a meaningful manner.

In addition, undesirable responses in the forms of various sources of noise, such as noise caused by geological features, noise generated by external EM sources, or noise internally generated in the EM system, may mask anomalous responses that are associated with valuable targets.

To date, the industry has focused on the measurement of one or more vector field components over a spatial range and at a range of frequencies or times, and has used a number of techniques for separating the measured fields of interest into a portion created by the source directly and a portion (the secondary ground response) generated by currents that the source induces to flow in the ground. Further, the means of separating the portion of the field discerned as produced by the ground in order to attribute to isolated targets are achieved with varying success based on spatial or time or frequency characteristics of the fields.

For example, U.S. Pat. No. 4,367,439 proposed a system for measuring the response using two or three mutually orthogonal coils and then using the differences between the measurements of mutually orthogonal fields to isolate localized targets from the background earth response. This system, however, is limited to frequency domain applications and is quite complicated as it in effect constitutes multiple transmitter/receiver coil-pair systems operating in parallel. A time domain EM system referred to in, for example, Australian Patent Publication 2009100027 would suggest separating the primary and secondary fields based on strong gradients coming from the transmitter and weaker gradients from the targets in the ground. The suggested approach, however, only attempts to correct for direct coupling between the transmitter loop and the receiver coil and is not directed to removing background geological noise. Another International Patent Publication WO2010/071990A1 discusses measuring multiple components of the electromagnetic field and using the vector nature of the electromagnetic field to characterize the ground using the response as a whole and a paper by Hardwick, C. D., titled “Important design considerations for inboard airborne magnetic gradiometers”, Geophysics, 49, 2004-2018 (1984), mentions measuring the gradients of static magnetic field with no temporal variation.

A paper by Dransfield, M. and Zeng, Y., entitled “Airborne gravity gradiometry: Terrain corrections and elevation error”, Geophysics, 74, 137-142 (2009), refers to the processing of gravity gradients data, whereas the measurement of gradients in electromagnetic measurements was proposed in a paper by Sattel, D. and Macnae, J. C., entitled “The feasibility of EM gradiometer measurements”, Geophysical Prospecting, 49, 309-320 (2001), but the anomalous responses are dominated by the source and background responses.

None of the above prior art systems, however, concerns the measurement of the spatial gradients for EM systems and the related signal analysis for the purpose of identifying anomalous features in a background material.

Therefore, there remains a need for simple and effective EM systems and methods that overcome the drawbacks of the prior art systems and minimize geological and system noise using electromagnetic fields and gradients.

### SUMMARY OF THE INVENTION

An object of the present invention is to provide simple and effective systems and methods for minimizing geological and system noise using electromagnetic fields and gradients, thereby allowing meaningful recognition and characterization of underground targets of interest.

The present invention focuses on the use of the electromagnetic fields and the spatial and/or temporal gradients of the fields to separate the secondary ground response field into background earth response and localized target response.

In accordance with one aspect of the present invention, there is provided a method for processing electromagnetic field measurements from a survey of an underground target embedded in a background material, the method comprising: combining at least one electromagnetic field gradient such that measurements associated with the target are enhanced and measurements associated with the background material or the primary electromagnetic field are suppressed.

In accordance with another aspect of the present invention, there is provided a system for processing electromagnetic field measurements from a survey of an underground target embedded in a background material, the system comprising: (a) means for receiving the electromagnetic field measurements; (b) a processing unit for combining at least one electromagnetic field gradient such that measurements associated with the target are enhanced and measurements associated with the background material or the primary electromagnetic field are suppressed; and (c) means for outputting the enhanced measurements.

In accordance with another aspect of the present invention, there is provided a method for surveying an underground target embedded in a background material, the method comprising: (a) generating a primary electromagnetic field that induces a response electromagnetic field; (b) obtaining the response electromagnetic field measurements; and (c) processing the response electromagnetic field measurements using at least one electromagnetic field gradient such that measurements associated with the target are enhanced and measurements associated with the background material or the primary electromagnetic field are suppressed.

In accordance with another aspect of the present invention, there is provided an airborne electromagnetic system for surveying an underground target embedded in a background material, the system comprising: a transmitter for generating a primary electromagnetic field that induces a response electromagnetic field; one or more receivers for measuring the response electromagnetic field; and means for processing the response electromagnetic field measurements using at least one electromagnetic field gradient such that measurements associated with the target are enhanced and measurements associated with the background material or the primary electromagnetic field are suppressed.

In accordance with another aspect of the present invention, there is provided a computer readable memory having recorded thereon statements and instructions for execution by a computer for processing electromagnetic field measurements from a survey of an underground target embedded in a background material, said statements and instructions comprising: (a) means for applying at least one electromagnetic field gradient to the electromagnetic field measurements such that measurements associated with the target are enhanced and measurements associated with the background material or the primary electromagnetic field are suppressed.

In accordance with another aspect of the present invention, there is provided a method for processing electromagnetic field responses from a survey of an underground target embedded in a background material, the method comprising: (a) identifying a combination of field gradients that will suppress or be null to large scale spatially slowly varying responses and enhance localized responses; and (b) filtering the electromagnetic field responses using said combination of field gradients thereby enhance identification of the underground target.

In accordance with another aspect of the present invention, there is provided a method for processing electromagnetic field responses from a survey of an underground target embedded in a background material, the method comprising: (a) identifying a combination of field gradients that will suppress or be null to large scale spatially slowly varying responses and enhance localized responses in such a way that an in-phase response of the localized responses is maintained; and (b) filtering the electromagnetic field responses using said combination of field gradients thereby enhance identification of the underground target.

In accordance with another aspect of the present invention, there is provided a method for processing electric or magnetic field measurements, the method comprising: (a) identifying a combination of fields and gradients of the fields that create an estimate for a second field; (b) obtaining measurements of fields and field gradients indentified; (c) measuring the second field; and (d) combining the estimated second field and the measured second field to improve the signal-to-noise ratio thereof.

In accordance with another aspect of the present invention, there is provided a method for processing electric or magnetic field measurements, the method comprising: (a) identifying a combination of fields and gradients of fields for estimating a second field; (b) obtaining measurements of fields and field gradients so indentified; and (c) combining the measured fields and gradient fields to create an observation of the second field without measuring the second field.

Other features and advantages of the present invention will become apparent from the following detailed description and the accompanying drawings, which illustrate, by way of example, the principles of the invention.

### BRIEF DESCRIPTION OF THE DRAWINGS

The invention will now be described by way of reference to the drawings, in which:

FIG. 1 is a graphical illustration of a method for analyzing anomalous field in a background;

FIG. 2 is a flow chart showing a method in accordance with an embodiment of the present disclosure;

FIG. 3 is a plot chart showing measured response for a layered earth embedding an anomalous body;

FIG. 4 is a plot of indicator quantities in accordance with an embodiment of the present disclosure;

FIG. 5 is a flow chart showing a method in accordance with an embodiment of the present disclosure;

FIG. 6 is a flow chart showing a method in accordance with an embodiment of the present disclosure;

FIG. 7 is a flow chart showing a method in accordance with an embodiment of the present disclosure.

### DETAILED DESCRIPTION OF THE INVENTION

The purpose of exploration survey measurements is in general to identify localized zones of material with differing physical properties and which have economic significance. Such zones are generally embedded in the background earth material which has more spatially uniform electrical and magnetic (electromagnetic) properties. Any spatial variation in the electromagnetic properties is assumed to vary most strongly as a function of increasing depth and more weakly in the lateral direction. Since both the localized target zones and the background create differing measurable EM responses, techniques that preferentially enhance the localized response and suppress the background response are of great benefit to the geophysical exploration process.

The present disclosure describes the use of spatial gradients of the fields to create a filtering process that enhances the responses of the localized anomalous features and suppresses the responses of the background.

The present disclosure further describes the use of spatial gradients to estimate temporal rates of change of other field components thereby providing a different and independent means of determining an observable field component. For example, spatial gradients of the magnetic field can be used to estimate the time derivative of the electric field.

A brief overview of EM field basics is helpful in describing the system and method disclosed herein.

From fundamental physics (Maxwell's equations), we know that

$$\begin{matrix}∇ \times B = μ {J}_{s} + σ μ E + ɛ μ \frac{\partial E}{\partial t} & ( 1 ) \\ ∇ \times E = - \frac{\partial B}{\partial t} & ( 2 ) \\ ∇ \cdot B = 0 & ( 3 ) \\ ∇ \cdot E = q & ( 4 )\end{matrix}$$

where
B is the magnetic flux density
E is the electric field strength
Jₛ is an electrical excitation current creating the E and B fields
q is the electric charge density
ε is the dielectric permittivity of the local material
μ is the magnetic permeability of the local material
σ is the electrical conductivity of the local material

All quantities are functions of spatial position which, if we use a Cartesian coordinate system, are expressed as (x,y,z) and are in the spatial direction defined by unit vectors (e₁,e₂,e₃). The symbol t represents time.

The spatial derivative operators are expressed as

$$\begin{matrix}∇ \times A = {e}_{1} ( \frac{\partial {A}_{z}}{\partial y} - \frac{\partial {A}_{y}}{\partial z} ) - {e}_{2} ( \frac{\partial {A}_{z}}{\partial x} - \frac{\partial {A}_{x}}{\partial z} ) + {e}_{3} ( \frac{\partial {A}_{y}}{\partial x} - \frac{\partial {A}_{x}}{\partial y} ) & ( 5 ) \\ ∇ \cdot A = \frac{\partial {A}_{x}}{\partial x} + \frac{\partial {A}_{y}}{\partial y} + \frac{\partial {A}_{z}}{\partial z} & ( 6 )\end{matrix}$$

The temporal variation may be Fourier transformed to a frequency domain in which case the time derivative can be expressed as

$$\frac{\partial }{\partial t} ↔ i ω \qquad ( 7 )$$

where ω is the angular frequency. The electromagnetic fields are then characterized in the frequency domain and referred herein to as field spectra or simply spectra.

Current industry practice is for EM methods to measure some of the components of the E and B vector fields and use the observed fields at one location to infer the presence of changes in electromagnetic material properties (ε, μ, σ) at an inaccessible location. For example, fields are measured above the ground to see variations in the properties below the ground surface.

Two key factors determine how EM measurements are deciphered and examined. The first consideration is the nature of source of the fields (i.e. the source location and temporal (or spectral content) and vector component(s) created). The second factor is the spatial variation in the material properties.

The well known approach is to divide the fields into what are called ‘primary’ and ‘secondary’ quantities where the primary fields are associated with the source alone and the secondary are associated with any change in the material properties.

Cogent to the present invention is the recognition that the material properties can be split into a background variation, which is spatially static or very slowly varying, and a local anomalous variation.

The present disclosure builds on the equivalent source approach to formulating EM responses. This approach recasts the variations in materials as a distribution of unknown sources creating distinct field contributions as expressed here. Details of this approach are in a 1974 Ph.D. thesis by Annan, A. P., entitled “The equivalent source method for electromagnetic scattering analysis and its geophysical application”, submitted to the Memorial University of Newfoundland and in a scientific paper by Hohmann, G. W., 1988, entitled “Numerical modeling for electromagnetic methods in geophysics”, in Nabighian, M. N. (ed), Electromagnetic methods in applied geophysics, Volume 1, Investigations in Geophysics, Vol. 3. Society of Exploration Geophysicists, Tulsa, 313-363.

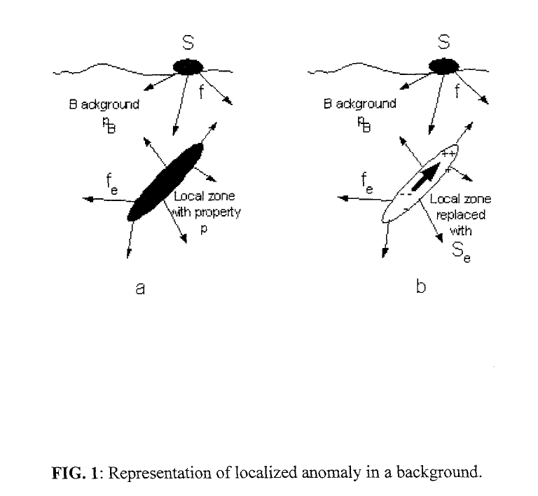

The concept is expressed in scalar form here for simplicity. Referring to FIG. 1, a localized target with differing properties is present in a media with a known response which can be characterized by the Green's function

g=(r,r′,t,t′) (8)

If a source is present and described in space and time as s(r,t), the fields created, f(x,t), are mathematically expressed as the convolution

f(r,t)=∫∫∫g(r,r′,t,t′)s(r′,t′)d³r′dt′ (9)

By describing the target as a difference in physical properties Δp=(p−p_{B}) incorporated in the background response Green's function, the excitation field f(r,t) will cause an apparent source signal

sₑ(r,t)=Δpf_{TOTAL}(r,t)=Δp(f(r,t)+fₑ(r,t)). (10)

This new equivalent source generates the response

fₑ(r,t)=∫∫∫g(r,r′,t,t′)sₑ(r′,t′)d³r′,dt′, (11)

with the source signal satisfying an integral equation of the form

sₑ(r,t)=Δpf(r,t)+Δp∫∫∫g(r,r′,t,t′)sₑ(r′,t′)d³r′dt′ (12)

As the above equivalent source concepts indicate, any field component can be segmented into three contributions. For example, the Eₓ electric field component can be expressed as

Eₓ=Eₓ^{p}+Eₓ^{b}+Eₓ^{a} (13)

where the superscript p denotes the primary response, b denotes the background response and a denotes the anomalous response. And a material property can also be segmented into two components

σ=σ_{b}+σₐ (14)

As a general rule, magnitudes of the contributing parts of a field component can differ greatly with

E^{p}>>E^{b}>>E^{a} (15)

As such, obtaining a reliable measure of the anomalous field response must usually be achieved in the presence of often much larger responses. In addition, uncertainties in observation position or inability to independently determine E^{p} may limit response sensitivity. EM systems traditionally seek techniques to eliminate or minimize E^{p} to detect E^{b}. For example, using appropriate source geometry can make E^{p} null therefore allowing E^{b} to be more readily measured. Spectral character and temporal behavior can also be used to separate the primary contribution E^{p} from secondary contribution E^{b}. Furthermore, as a portion of the primary fields and the material property variation fields will be orthogonal in phase (except for the case of perfectly conducting materials), prior art systems have exploited this feature to obtain higher sensitivity for material property variations at the expense of extracting the common in-phase signal, as discussed in a paper by Smith, R. S., 2001, “On removing the primary field from fixed-wing time-domain airborne electromagnetic data: some consequences for quantitative modeling, estimating bird position and detecting perfect conductors”, Geophysical Prospecting, 49, 405-416.

As system sensitivities have increased, the need to identify local variations (εₐ, μₐ, σₐ) within the background material has become increasingly necessary and challenging. The systems and methods described herein use combinations of field gradients as well as the fields themselves to obtain or improve estimates of the anomalous field (i.e., E^{a}), using concepts heretofore unexploited.

The system and method described herein can be deployed or applied in various source configurations and different conductivity distributions. The permutations and combinations of possible sources and material distributions are endless. Accordingly, only simple cases will be presented which illustrate the example embodiments of the systems and methods described herein.

A common building block for describing EM responses is to use constructs such as plane-wave decomposition to build more complex source and environment responses. In the following, we consider a plane wave travelling in the x-z (e₁-e₃) plane and with B field contained in the same plane and the E field in the direction normal to the plane (in the y or e₂ direction). More complex problems can be constructed by summing together multiple plane waves of different wavelengths, as described by Ward, S. H. and Hohmann, G. W., 1988, Electromagnetic theory for geophysical applications, in Nabighian, M. N. (ed.), Electromagnetic methods in applied geophysics—Theory, Volume 1, Investigations in Geophysics, vol. 3. Society of Exploration Geophysicists, Tulsa, 130-311.

Illustration 1:

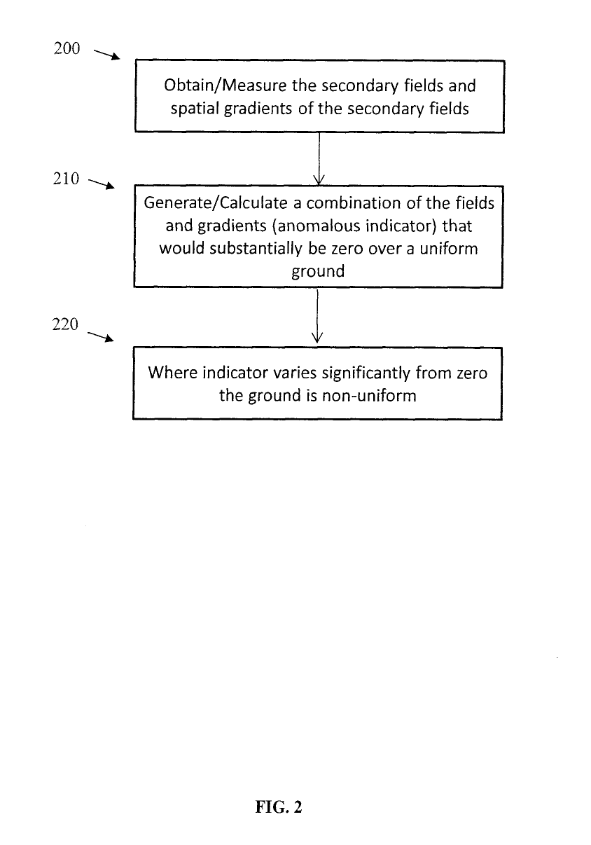

Referring to FIG. 2 and in accordance with one embodiment of the system and method described herein, the response electromagnetic field measurements can be processed using an anomalous indicator to enhance measurements associated with the anomalous field and suppress or remove undesirable signals associated with a uniformly conductive ground.

FIG. 2 shows a flowchart that describes a method or process of removing the unwanted signals, which in this example are the secondary fields coming from a uniformly conductive ground (for example an overburden). The method comprises the steps of obtaining or measuring the response fields and gradients of the fields 200, and processing the response electromagnetic field measurements using at least one electromagnetic field gradient such that measurements associated with non-uniform ground are enhanced and measurements associated with uniform ground are suppressed 210, 220.

The system used for obtaining or measuring the response fields can be a standard electromagnetic system using industry standard transmitter and receiver technology.

Preferably, the system is capable of measuring or calculating the spatial gradients. The spatial gradient can be measured by deploying more than one sensor. For example, in an industry standard electromagnetic system, the vertical component of the magnetic field is measured with a vertical axis induction coil. If a second sensor is placed above the first sensor, the vertical gradient of the vertical field can be acquired by subtracting the signal at the first sensor from the signal at the second sensor and then dividing the result by the distance between the two sensors. This can be done electronically, in firmware or software in real time or in a computer after the data is acquired. Other spatial gradients can be acquired by offsetting the sensors in different directions. The spatial gradients of other components can be acquired by using a different orientation (not the vertical component). Alternatively, the gradients may be measured using some other sensor designed specifically for measuring gradients. The exact means for acquiring the gradients information is not the subject of this disclosure as those experienced in the art should be able to measure the gradients.

In some embodiments, the processing of the response fields and gradients involves combining the response fields and/or gradients to generate or calculate a linear indicator that substantially has a value of zero over a uniform ground 210 and a non-zero value or varies significantly from zero where the ground is non-uniform 220. The indicator can then be plotted in graphical or other representation form so that spatial positions where the indicator deviates significantly from zero in some geologically meaningful way could be used to identify where the ground is not uniform 220. Such non-uniform areas might be indicative of where there are valuable subsurface resources.

Anomalous indicators can be created in a number of ways. For example, the indicators can be identified or created by analyzing EM fields as described herein.

In some embodiments, an anomalous indicator can be created using the divergence operator for the B field (the third of Maxwell's equations listed above).

∇·B=∇·B^{p}+∇·B^{b}+∇·B^{a} (1.1)

If the excitation generates a field in the x-z plane and the background material only varies in the z direction, then the primary and background responses both have B_{y}=0. A measurement of the B field and its gradients in the x-z plane could yield the following:

$${B}_{x} , {B}_{z} , \frac{\partial {B}_{x}}{\partial x} , \frac{\partial {B}_{x}}{\partial z} , \frac{\partial {B}_{z}}{\partial x} , \frac{\partial {B}_{z}}{\partial z} \qquad ( 1.2 )$$

Examining the B field divergence shows that

$$\begin{matrix}∇ \cdot B = ∇ \cdot {B}^{p} + ∇ \cdot {B}^{b} + ∇ \cdot {B}^{a} = 0 & ( 1.3 ) \\ ∇ \cdot {B}^{p} = \frac{\partial {B}_{x}^{p}}{\partial x} + \frac{\partial {B}_{z}^{p}}{\partial z} = 0 & ( 1.4 ) \\ ∇ \cdot {B}^{b} = \frac{\partial {B}_{x}^{b}}{\partial x} + \frac{\partial {B}_{z}^{b}}{\partial z} = 0 & ( 1.5 ) \\ ∇ \cdot {B}^{a} = \frac{\partial {B}_{x}^{a}}{\partial x} + \frac{\partial {B}_{y}^{a}}{\partial y} + \frac{\partial {B}_{z}^{a}}{\partial z} = 0 & ( 1.6 )\end{matrix}$$

which leads to the conclusion that adding the x gradient of the total field x component to the z gradient of the total field z component measurements together gives

$$\frac{\partial {B}_{x}}{\partial x} + \frac{\partial {B}_{z}}{\partial z} = - \frac{\partial {B}_{y}^{a}}{\partial y} = I \qquad ( 1.7 )$$

where I is an indicator which depends on the local material property variation. If there is no anomalous material then B_{y}^{a} will be zero and the indicator will substantially be zero. If there is an anomalous zone, then the indicator will be non-zero.

Similarly, if the source generates a field in the y-z plane and the background material only varies in the y direction, then the anomalous indicator may be generated by combining the y gradient of the total field y component and the z gradient of the total field z component measurements.

In other words, the above combination of gradients of the response field can be applied to enhance response measurements associated with the anomalous material and suppress response measurements associated with the background material.

This illustration demonstrates that combining one or more gradients of the total measurable field in what is essentially a filter operation can yield an anomalous response indicator when the source and background fit a predefined structure. For example, the above indicator may be applied to the detection of anomalous material in a geological background that is substantially uniform in at least one direction.

It is noteworthy that the gradient combination does not depend on separating the signals into orthogonal (in-phase or out-of-phase) components in the time or frequency domain so that the total anomalous signal (in-phase and orthogonal) may be observed. Advantageously, this means that when attempting to identify highly conductive materials (i.e. highly conductive anomalous zones) the indicator will substantially be zero for zones having no anomalous material and be non-zero when a highly conductive material is present.

Illustration 2:

Other example indicators can be generated to reject unwanted signals associated with the uniform ground or overburden while enhancing the anomalous responses associated with non-uniform property zones.

Using the same plane wave building unit, one can look at the Ampere's law

$$∇ \times B = μ {J}_{s} + σμ E + ɛμ \frac{\partial E}{\partial t} \qquad ( 2.1 )$$

In air above the ground and away from the source becomes

$$∇ \times B = \frac{1}{{c}^{2}} \frac{\partial E}{\partial t} \approx 0 \qquad ( 2.2 )$$

at slow excitation rate changes, where c=(εμ)^{-1/2}, the speed of light.

The operation yields

$$\begin{matrix} ∇ \times B = ∇ \times {B}^{p} + ∇ \times {B}^{b} + ∇ \times {B}^{a} \approx 0 & ( 2.3 ) \\ ∇ \times {B}^{p} = {e}_{1} ( \frac{\partial {B}_{z}^{p}}{\partial y} - \frac{\partial {B}_{y}^{p}}{\partial z} ) - {e}_{2} ( \frac{\partial {B}_{z}^{p}}{\partial x} - \frac{\partial {B}_{x}^{p}}{\partial z} ) + {e}_{3} ( \frac{\partial {B}_{y}^{p}}{\partial x} - \frac{\partial {B}_{x}^{p}}{\partial y} ) \text{=>} - {e}_{2} ( \frac{\partial {B}_{z}^{p}}{\partial x} - \frac{\partial {B}_{x}^{p}}{\partial z} ) & ( 2.4 ) \\ ∇ \times {B}^{b} = {e}_{1} ( \frac{\partial {B}_{z}^{b}}{\partial y} - \frac{\partial {B}_{y}^{b}}{\partial z} ) - {e}_{2} ( \frac{\partial {B}_{z}^{b}}{\partial x} - \frac{\partial {B}_{x}^{b}}{\partial z} ) + {e}_{3} ( \frac{\partial {B}_{y}^{b}}{\partial x} - \frac{\partial {B}_{x}^{b}}{\partial y} ) \text{=>} - {e}_{2} ( \frac{\partial {B}_{z}^{b}}{\partial x} - \frac{\partial {B}_{x}^{b}}{\partial z} ) & ( 2.5 ) \\ ∇ \times {B}^{a} = {e}_{1} ( \frac{\partial {B}_{z}^{a}}{\partial y} - \frac{\partial {B}_{y}^{a}}{\partial z} ) - {e}_{2} ( \frac{\partial {B}_{z}^{a}}{\partial x} - \frac{\partial {B}_{x}^{a}}{\partial z} ) + {e}_{3} ( \frac{\partial {B}_{y}^{a}}{\partial x} - \frac{\partial {B}_{x}^{a}}{\partial y} ) & ( 2.6 )\end{matrix}$$

where the => symbols imply the relationship when there is no spatial variation of material properties in the y direction. Since the normal condition is a state when B^{a}=0 and B^{a} will decrease rapidly in magnitude away from the anomalous zones where there is a localized property variation, defining an indicator

$$F = \frac{\partial {B}_{x}}{\partial z} - \frac{\partial {B}_{z}}{\partial x} \qquad ( 2.7 )$$

results in F=0 away from the anomalous zone; while F is non-zero we will have a measure of anomalous response in the vicinity of a local disturbance.

Accordingly, the method and system described herein may combine the response fields and/or gradients to generate or calculate the above F indicator which would substantially have a value of zero over a uniform ground 210 and a non-zero value where the ground is non-uniform 220. The indicator can then be plotted in graphical or other representation form so that locations where the indicator deviates significantly from zero could be used to identify where the ground is non-uniform 220. Such non-uniform areas might be indicative of where valuable subsurface resources are located.

Illustration 3:

In some embodiments that involve cylindrically symmetric (dipole) excitation sources, other forms of indicators can be generated or calculated.

In one example embodiment, we use the cylindrical coordinate system and calculate the electromagnetic response of a layered ground to a dipole transmitter oriented in the vertical (z) direction. The z (vertical) and ρ (radially horizontal) components of the secondary magnetic field response H of a layered earth are given in Ward and Hohmann (1988) as shown below.

$$\begin{matrix}{H}_{ρ} = \frac{m}{4 π} {\int }_{0}^{∞} {r}_{TE} {e}^{λ ( z - h )} {λ}^{2} {J}_{1} ( λ ρ ) d λ , \\ and & ( 3.1 ) \\ {H}_{z} = \frac{m}{4 π} {\int }_{0}^{∞} {r}_{TE} {e}^{λ ( z - h )} {λ}^{2} {J}_{0} ( λρ ) d λ , & ( 3.2 )\end{matrix}$$

where m is the dipole moment of the transmitter, r_{TE} is the reflection coefficient for a horizontally layered earth, λ is the wave number, ρ is the horizontal offset of the receiver from the transmitter and Jₗ is the Bessel function order l. Following Ward and Hohmann (1988), z is positive downward with z=0 being the ground surface, so the receiver being above the ground will have a negative z value, but the h is the height of the transmitter and h is positive above the ground.

Taking the gradient with respect to ρ of equation (3.1) gives

$$\frac{d {H}_{ρ}}{d ρ} = \frac{m}{4 π} {\int }_{0}^{∞} {r}_{TE} {e}^{λ ( z - h )} {λ}^{2} \frac{d {J}_{1} ( λρ )}{d x} d λ . \qquad ( 3.3 )$$

The gradient of the first-order Bessel function can be evaluated using

$$\frac{d {J}_{1} ( λρ )}{d ρ} = λ {J}_{0} ( λρ ) - {J}_{1} ( λρ ) / ρ , \qquad ( 3.4 )$$

which when substituted in (3.3) can be shown to give

$$\frac{d {H}_{ρ}}{d ρ} = \frac{d {H}_{z}}{d z} - \frac{{H}_{ρ}}{ρ} , \qquad ( 3.5 )$$

as the additional λ in the integral can be generated by taking a gradient with respect to z.

Similarly, taking the ρ gradient of equation (3.2) gives

$$\frac{d {H}_{z}}{d ρ} = - \frac{d {H}_{ρ}}{d z} . \qquad ( 3.6 )$$

We define an indicator Δ_{L} that involves like gradients and components

$${Δ}_{L} = \frac{d {H}_{ρ}}{d ρ} - \frac{d {H}_{z}}{d z} + \frac{{H}_{ρ}}{ρ} . \qquad ( 3.7 )$$

and another quantity λ_{X} with cross gradients and components

$${Δ}_{X} = \frac{d {H}_{z}}{d ρ} + \frac{d {H}_{ρ}}{d z} . \qquad ( 3.8 )$$

Using equation (3.5) and (3.6), both these indicators should substantially be zero for a layered conductive half space. This means that when the quantities are not zero, there is an indication of an anomalous body, possibly a mineral deposit. The calculation of the indicator quantity is the filtering process.

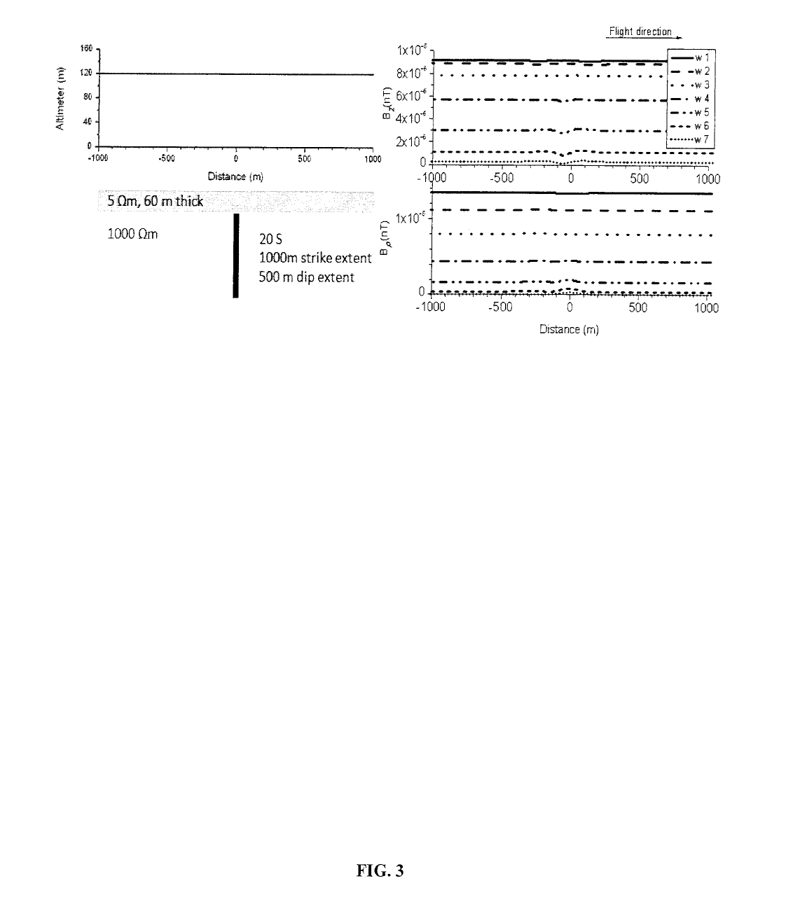

FIG. 3 shows the H_{z} and H_{ρ} responses for a layered earth with an anomalous body representative of a mineral deposit in the centre of the profile. Note that the centre body has a very subtle response that is swamped in the large background response of the layered earth (right panels).

The target material in FIG. 3 is a vertical conductor, the geo-electric model of which is characterized by a conductance of 20 S with a 1000 m strike extent and a 500 m dip extent. The vertical conductor is buried in a 1000 Ωm material below a conductive overburden of 5 Ωm and with a thickness of 60 m. In this example, the surveying airborne EM system includes a vertical-dipole transmitter, and a receiver towed 50 m below and 130 m behind the transmitter for measuring the vertical z-component and horizontal ρ-component responses. The altitude of the aircraft is shown at the top left panel of FIG. 3 and is 120 m across the whole profile. The z-component and ρ-component responses are shown at right in the top and bottom panels respectively. W1 to W7 are measurement windows from early (W1) to late (W7) delay times.

In accordance with the method and system described herein, the measured z-component and ρ-component responses are processed using the above cross gradients indicator Δ_{X} and like gradients indicator Δ_{L} to enhance measurements associated with non-uniform ground and suppress measurements associated with uniform ground.

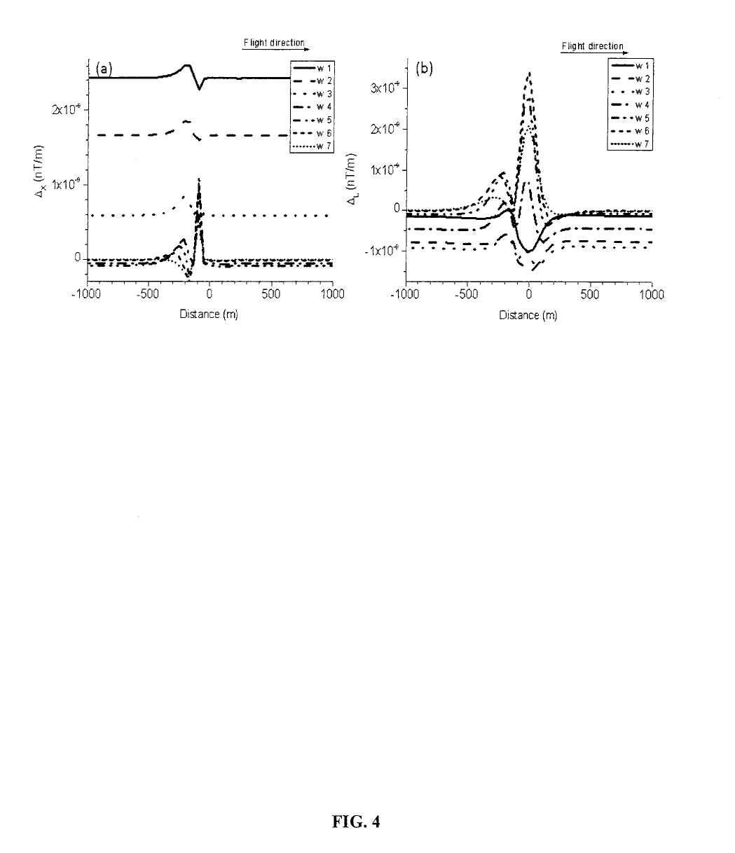

For example, a plot of the indicator quantities is shown on FIG. 4. The combinations of gradients involving cross-gradient terms and like-gradient terms are plotted in panel (a) and panel (b) respectively. As shown in FIG. 4, the processing has reduced the background response to close to zero and the anomaly-to-background ratio is large on both the cross-gradient and like-gradient combinations. As a result, the anomalous response from the non-layered earth structure is clearly visible. This illustrates how the filtering process has enhanced the response of the anomalous body and suppressed background response.

Illustration 4:

In another example embodiment, we consider the cylindrical coordinate system and calculate the electromagnetic response of a layered ground to a dipole transmitter oriented in the horizontal (x) direction.

In this case, the z and ρ components of the secondary magnetic field response H of a layered earth when excited by a horizontal dipole x-directed transmitter are given in Ward and Hohmann (1988)

$$\begin{matrix}{H}_{ρ} = \frac{m}{4 π} ( \frac{1}{ρ} - \frac{2 {x}^{2}}{{ρ}^{3}} ) {\int }_{0}^{∞} {r}_{TE} {e}^{λ ( z - h )} λ {J}_{1} ( λρ ) d λ + \frac{m}{4 π} \frac{{x}^{2}}{{ρ}^{2}} {\int }_{0}^{∞} {r}_{TE} {e}^{λ ( z - h )} {λ}^{2} {J}_{0} ( λρ ) d λ , \\ and & ( 4.1 ) \\ {H}_{z} = \frac{m}{4 π} \frac{x}{ρ} {\int }_{0}^{∞} {r}_{TE} {e}^{λ ( z - h )} {λ}^{2} {J}_{1} ( λρ ) d λ , & ( 4.2 )\end{matrix}$$

where the symbols are as noted before, but the dipole is oriented along the x axis and ρ=√(x²+y²). If we assume that the receiver is below the dipole axis, then y=0 and ρ=x, giving

$$\begin{matrix}{H}_{ρ} = - \frac{m}{4 π} \frac{1}{ρ} {\int }_{0}^{∞} {r}_{TE} {e}^{λ ( z - h )} λ {J}_{1} ( λρ ) d λ + \frac{m}{4 π} {\int }_{0}^{∞} {r}_{TE} {e}^{λ ( z - h )} {λ }^{2} {J}_{0} ( λρ ) d λ , & ( 4.3 ) \\ and & \\ {H}_{z} = \frac{m}{4 π} {\int }_{0}^{∞} {r}_{TE} {e}^{λ ( z - h )} {λ }^{2} {J}_{1} ( λρ ) d λ , & ( 4.4 )\end{matrix}$$

Taking the gradient with respect to ρ of equation (4.4) gives

$$\frac{d {H}_{z}}{d ρ} = \frac{m}{4 π} {\int }_{0}^{∞} {r}_{TE} {e}^{λ ( z - h )} {λ }^{2} \frac{d {J}_{1} ( λρ )}{d p} d λ . \qquad ( 4.5 )$$

Using equation (3.4) gives

$$\frac{d {H}_{z}}{d ρ} = \frac{m}{4 π} {\int }_{0}^{∞} {r}_{TE} {e}^{λ ( z - h )} {λ }^{2} ( λ {J}_{0} ( λρ ) - {J}_{1} ( λρ ) / ρ ) d λ . \qquad ( 4.6 )$$

Comparing this with equation (4.3) we can write

$$\frac{d {H}_{z}}{d ρ} = - \frac{d {H}_{ρ}}{d z} . \qquad ( 4.7 )$$

which is the same as equation (3.6). Hence, like the vertical dipole case, a cross-gradients indicator

$${Δ}_{X} = \frac{d {H}_{z}}{d ρ} + \frac{d {H}_{ρ}}{d z}$$

can be created. This indicator should be substantially zero for a layered conductive half space. This means that when the quantities are not zero, there is an indication of an anomalous body, possibly a mineral deposit. The calculation of the indicator quantity is the filtering process.

As a person skilled in the art would appreciate, for the case of a y-directed dipole transmitter, a similar indicator may be generated on the basis that the vertical and horizontal (x) gradients of the radial and vertical fields are zero on the x axis.

Accordingly, for cylindrically symmetric (dipole) excitation sources, the method and system described herein may combine the response fields and gradients to generate or calculate the above noted cross-gradient indicators or like-gradient indicators that would substantially have a value of zero over a uniform ground 210 and a non-zero value where the ground is non-uniform 220. The indicators can then be plotted in graphical or other representation form so that locations where the indicator deviates significantly from zero could be used to identify where the ground is non-uniform 220. Such non-uniform areas might be indicative of where valuable subsurface resources are located.

Those experienced in the art will recognize that the indicator Δ_{X} is robust to the case when a transmitter which is supposed to be vertical (illustration 3) pitched and has a component in the x direction.

Illustration 5:

Gauss's law in differential form is ∇·B=0, or equivalently, ∇·H=0. In circular cylindrical coordinates (suitable for dipole sources), the later equation is, according to Ward and Hohmann (1988):

$$\frac{1}{ρ} \frac{d ( ρ {H}_{ρ} )}{d ρ} + \frac{1}{ρ} \frac{d {H}_{θ}}{d θ} + \frac{d {H}_{z}}{d z} = 0. \qquad ( 5.1 )$$

Using the chain rule for the first term and ignoring the second term, as the cylindrical symmetry means that there is no variation in the θ direction, results in

$$\frac{1}{ρ} {H}_{ρ} + \frac{d {H}_{ρ}}{d ρ} + \frac{d {H}_{z}}{d z} = 0. \qquad ( 5.2 )$$

The coordinate of the EM system assumes that z is directed upwards, so

$$\frac{1}{ρ} {H}_{ρ} + \frac{d {H}_{ρ}}{d ρ} - \frac{d {H}_{z}}{d z} = 0. \qquad ( 5.3 )$$

The left-hand-side of equation 5.3 is indicator Δ_{L} in equation 3.7, so this is an alternate derivation to show that cylindrically symmetric grounds (e.g. layered earths) have a zero Δ_{L}.

The differential form of Faraday's law of induction is

$$∇ \times H = σ E + ɛ \frac{d E}{d t} . \qquad ( 5.4 )$$

The θ component of ∇×H is

$$\frac{d {H}_{ρ}}{d z} - \frac{d {H}_{z}}{d ρ} = σ {E}_{θ} + ɛ \frac{d {E}_{θ}}{d t} . \qquad ( 5.5 )$$

At the receiver, σ=0 and we make the quasi-static assumption ε=0, so with an appropriate modification due to the z direction being reversed, gives

$$\frac{d {H}_{ρ}}{d z} + \frac{d {H}_{z}}{d ρ} = 0. \qquad ( 5.6 )$$

The left-hand-side of equation 5.6 is indicator Δ_{X} in equation 3.8, so this quantity is also zero.

The other components of ∇×H do not provide any other relations between gradient components, as the cylindrical symmetry removes the components associated with θ gradients.

Illustration 6:

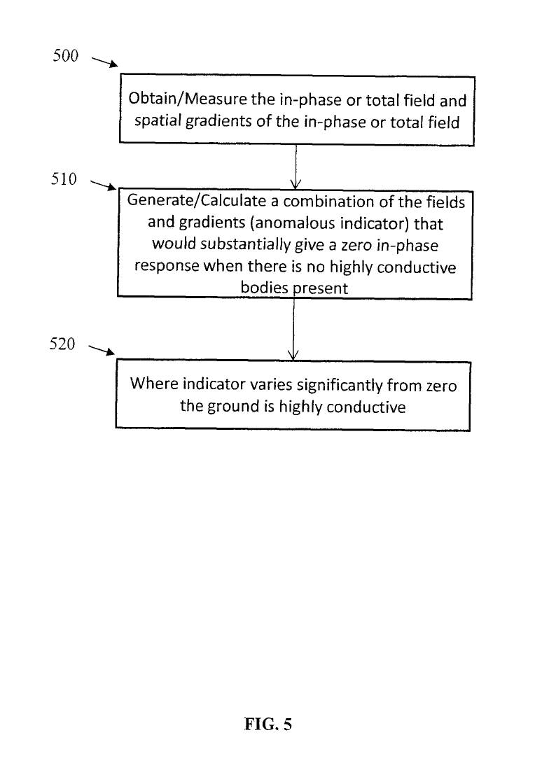

Referring to FIG. 5 and in accordance with one embodiment of the system and method described herein, the electromagnetic field measurements can be processed using an anomalous indicator or filter to enhance measurements associated with the anomalous material and suppress or remove unwanted primary field signals associated with the transmitter of an EM system.

FIG. 5 shows a flowchart that describes a method of removing the unwanted signals, which in this case are the primary in-phase fields coming from the transmitter of an EM system. The method comprises the steps of obtaining or measuring the total or in-phase response field and the gradients of the total or in-phase response field 500, and processing the response electromagnetic field measurements using one or more electromagnetic field gradients such that measurements associated with highly conductive ground are enhanced and measurements associated with the transmitter field are suppressed 510, 520.

In some embodiments, the processing involves combining the response fields and gradients to generate or calculate an indicator that would substantially have a value of zero when there are no highly conductive materials present 510 and a non-zero value where the ground is highly conductive 520. The indicator can then be plotted in graphical or other representation form so that places where the indicator deviates significantly from zero in some geologically meaningful way could be used to identify where the ground is highly conductive 520. Such highly conductive areas might be indicative of where there are valuable subsurface resources.

In some embodiments, such as the cases involving a dipole source in free space, the equations for the primary field are given by equations 3.1, 3.2, 4.1, 4.2, except r_{TE} e^{λ(z-h)} is replaced by e^{-λ(z+h)}. The negative sign in the exponential expression means that two quantities need to be redefined. The quantity Δ_{X} with cross gradients becomes

$${Δ}_{X} = - \frac{d {H}_{z}}{d ρ} + \frac{d {H}_{ρ}}{d z} , \qquad ( 6.1 )$$

and this will be zero for a vertical and horizontal dipole. The quantity Δ_{L} that involves like gradients and components becomes

$${Δ}_{L} = \frac{d {H}_{ρ}}{d ρ} + \frac{d {H}_{z}}{d z} + \frac{{H}_{ρ}}{ρ} \qquad ( 6.2 )$$

and this will be zero for the vertical dipole case only. Using these equations we can remove the in-phase response of the primary field from the transmitter dipole. Any remaining field will be secondary in phase. This includes the case when the secondary field is in-phase with the primary. Hence, extremely conductive bodies can be identified by the nature of their gradient response independent of their temporal response.

For example, if the measured field is the total field, then applying the above noted indicators will substantially suppress the in-phase field from the transmitter to a zero value and the remaining or filtered quantity will be the in-phase and quadrature fields from the conductors in the ground. As highly conductive bodies in the ground will have only an in-phase component and less conductive bodies will have a quadrature component, it is possible to divide this ground response into in-phase and quadrature and identify whether or not it is a highly conductive body. Namely, the indicators should substantially be zero when there is no highly conductive material present 510. This means that when the indicator quantities are not zero, there is an indication of a highly conductive material 520, possibly a mineral deposit.

Still referring to FIG. 5, if the in-phase field is measured, then after applying the above noted indicators the field remaining after the filtering operation will be the in-phase response from the conductors in the ground. As highly conductive bodies in the ground will have only an in-phase component, it is possible to identify whether or not it is a highly conductive body. Namely, when the indicator quantities are not zero or vary significantly from zero, there is an indication of a highly conductive material 520, possibly a mineral deposit; and when the indicators quantities are substantially zero, there is no highly conductive material present 510. The indicators can then be plotted in some graphical form so that locations where they deviate significantly from zero in some geologically meaningful way could be used to identify where there are highly conductive bodies in the ground.

Illustration 7:

Illustration 2 discussed above can be continued further to demonstrate another aspect of the present invention. In the example geometry citied, a set of sensors mounted on an airplane could fly in the x-z plane (normally the x direction is defined as the horizontal direction with z being the vertical direction) and record fields in the x-z plane. Measurement of a field such as E_{y} may require a sensor length in the y direction that is impractical to fly with. The combination of magnetic field component gradients can provide a means to estimate the time derivative of the electric field indirectly.

Re-grouping Faraday's equation

$$\frac{1}{{c}^{2}} \frac{\partial E}{\partial t} = ∇ \times B \qquad ( 7.1 )$$

which yields

$$\frac{\partial {E}_{y}}{\partial t} = {c}^{2} ( \frac{\partial {B}_{x}}{\partial z} - \frac{\partial {B}_{z}}{\partial x} ) \qquad ( 7.2 )$$

This indicates that combining the in-plane magnetic field spatial gradients can provide an electric field rate of change with time estimate. (An alternate expression in the frequency domain is readily obtained by Fourier transform).

This result can be exploited in many ways. In one instance a field measure can be derived without measuring it. Advantageously, a linear combination of the fields and gradients can be used to estimate a field that is otherwise difficult to measure.

In a second instance, a derived and measured field may be obtained independently. Since the noise character of the two sensing processes can be very different, the two measures can be combined to obtain an improved signal-to-noise ratio.

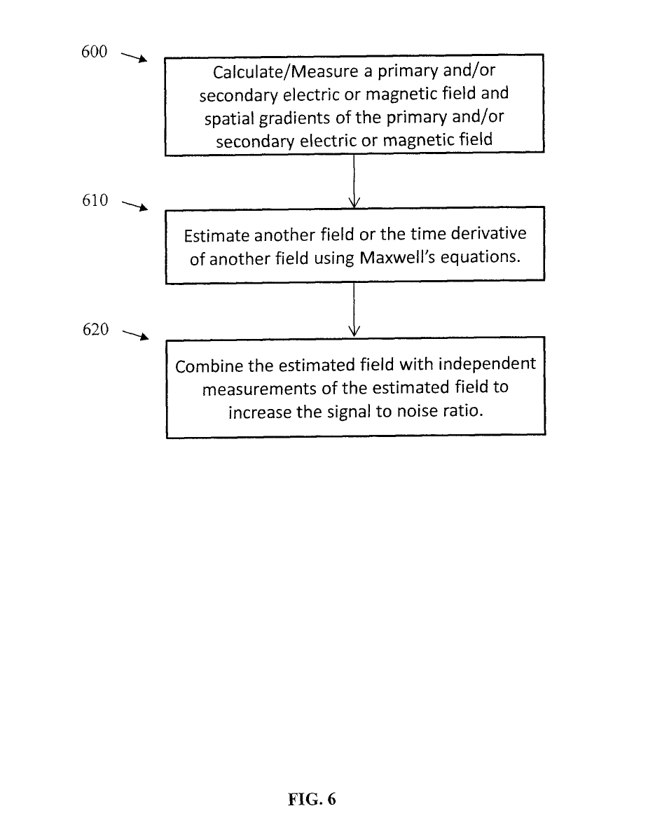

Referring to FIG. 6 and in accordance with one embodiment of the system and method described herein, the fields and the gradients are combined to give an estimate of another field which when combined with an independent estimate of the other field gives an improved signal-to-noise ratio.

FIG. 6 shows a flowchart that describes a method of estimating a field for enhancing or improving signal-to-noise ratio thereof. The method comprises calculating or measuring a primary and/or secondary electric or magnetic field and a combination of spatial gradients of the primary and/or secondary electric or magnetic field 600. These fields can be the primary and or the secondary fields. Next, the calculated or measured field and gradients are combined using Maxwell's equations to give an estimate of another field or the time derivative of another field 610. For example, using equation 7.2, the spatial gradients of the magnetic field can be used to give an estimate of the time derivative of the electric field. If there is another independent estimate of this field, then the two estimates could be combined together and the result would be an estimate with an improved signal-to-noise ratio 620. The independent measurement could be from another type of electric field sensor or derived from another set of spatial gradients of the magnetic field. Adding together a multiplicity of noisy estimates should give a lower noise estimate if there is not a consistent bias in the multiple estimates.

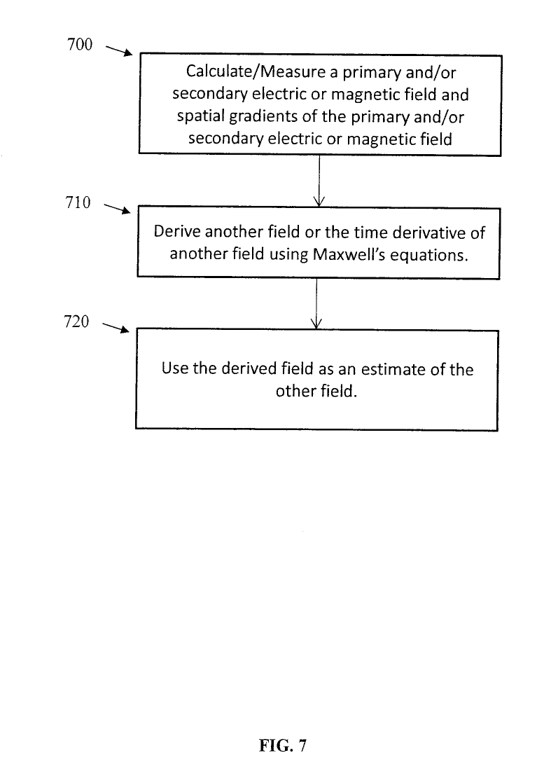

Referring to FIG. 7 and in accordance with one embodiment of the system and method described herein, the fields and the gradients are combined to give an estimate of another field.

FIG. 7 shows a flowchart that describes a method of estimating a field from measured fields and spatial gradients. The method comprises calculating or measuring a primary and/or secondary electric or magnetic field and a combination of spatial gradients of the primary and/or secondary electric or magnetic field 700. These fields can be the primary and or the secondary fields. Next, the calculated or measured field and gradients are combined using Maxwell's equations to give an estimate of another field or the time derivative of another field 710. For example, using equation 7.2, the spatial gradients of the magnetic field can be used to give an estimate of the time derivative of the electric field. The method thereby provides an estimated field which might not be readily measured or estimated using other means 720.

There are endless variations on the illustrations presented herein. The underlying principle is to combine EM field physics with geometrical reality to create signal analysis processes that deliver enhanced indicators of anomalous physical property variations in the proximity of an EM measurement system.

It will be understood that the methods disclosed herein, and each block of the flowchart illustrations and combinations of blocks in the flowchart illustrations, can be implemented by computer program instructions. These computer program instructions may be provided to a processor or other programmable data processing apparatus to produce a machine, such that the instructions which execute on the processor or other programmable data processing apparatus create means that implement the functions specified in the flowchart block or blocks. These computer program instructions may also be stored in a computer-readable memory that can direct a processor or other programmable data processing apparatus to function in a particular manner, such that the instructions stored in the computer-readable memory produce an article of manufacture including instruction means that implement the functions specified in the flowchart block or blocks. Accordingly, blocks of the flowchart illustrations can be implemented as combinations of means that perform the specified functions, combinations of steps that perform the specified functions and computer program products that perform the specified functions.

For example, the filtering processes described herein, namely the calculation of the selected indicator quantities or values at various spatial locations can be implemented as a standalone signal processing system or as computer process executable programs.

In addition, the display in graphical or quantitative form of the output of the filtering processing unit or program can be implemented in any suitable manner to enhance human identification of anomalous zones worthy of further evaluation.

Although the present invention has been described in considerable detail with reference to certain preferred embodiments thereof, other embodiments and modifications are possible. Therefore, the scope of the appended claims should not be limited by the preferred embodiments set forth in the examples, but should be given the broadest interpretation consistent with the description as a whole.

1. A method for processing electromagnetic field measurements from a survey of an underground target embedded in a background material, the method comprising:
receiving the electromagnetic field measurements that are indicative of the underground and the underground target;
applying at least one spatial derivative to the electromagnetic field measurements to calculate an indicator, wherein the indicator has a first value for a uniform portion of the underground and the indicator has a second value, different from the first value, for the underground target, such that measurements associated with the underground target are enhanced and measurements associated with a background material or a primary electromagnetic field are suppressed; and
based on the first and second values of the indicator, identifying a location of the underground target.

2-3. (canceled)

4. An airborne electromagnetic system for surveying an underground target embedded in a background material, the system comprising:
a transmitter for generating a primary electromagnetic field that induces response electromagnetic field measurements that are indicative of the underground and the underground target;
one or more receivers for measuring the response electromagnetic field measurements; and
a processor for processing the response electromagnetic field measurements using at least one spatial derivative to calculate an indicator, wherein the indicator has a first value for a uniform portion of the underground and the indicator has a second value, different from the first value, for the underground target, such that measurements associated with the underground target are enhanced and measurements associated with the background material or a primary electromagnetic field are suppressed.

5. A non-transitory computer readable medium including instructions for execution by a computer for processing electromagnetic field measurements from a survey of an underground target embedded in a background material, said statements and instructions comprising:
instructions for receiving the electromagnetic field measurements that are indicative of the underground and the underground target;
instructions for applying at least one spatial derivative to the electromagnetic field measurements to calculate an indicator, wherein the indicator has a first value for a uniform portion of the underground and the indicator has a second value, different from the first value, for the underground target, such that measurements associated with the underground target are enhanced and measurements associated with a background material or a primary electromagnetic field are suppressed; and
based on the first and second values of the indicator, instructions for identifying a location of the underground target.

6-9. (canceled)

10. The method of claim 1, further comprising:
calculating the indicator to include only spatial derivatives of the electromagnetic field measurements.

11. The method of claim 1, further comprising:
calculating the indicator to include only spatial derivatives of a B magnetic field.

12. The method of claim 1, further comprising:
calculating the indicator to include only spatial derivatives of a secondary magnetic field H.

13. The method of claim 1, further comprising:
calculating the indicator to include a sum of (i) spatial derivatives of the electromagnetic field measurements and (ii) the electromagnetic field measurements.

14. The method of claim 13, wherein the electromagnetic field measurements include only a secondary magnetic field H.

15. The method of claim 1, further comprising:
calculating the indicator to include a sum or difference of only spatial derivatives of the electromagnetic field measurements.

16. The method of claim 1, further comprising:
generating a primary electromagnetic field that induces the electromagnetic field measurements; and
generating a plot of the indicator based on which the location of the underground target is identified.

17. The method of claim 1, further comprising:
calculating the indicator as a combination of electromagnetic fields and spatial derivatives of the electromagnetic fields to create an estimate for a second electromagnetic field;
measuring the second electromagnetic field; and
combining the estimated second electromagnetic field and the measured second electromagnetic field to improve the signal-to-noise ratio thereof.

18. The method of claim 1, further comprising:
calculating the indicator as a combination of electromagnetic fields and spatial derivative of the electromagnetic fields to create an estimate for a second electromagnetic field, without measuring the second electromagnetic field.

19. The system of claim 4, wherein the processor is further configured to:
calculate the indicator to include only spatial derivatives of the electromagnetic field measurements.

20. The system of claim 4, wherein the processor is further configured to:
calculate the indicator to include only spatial derivatives of a B magnetic field.

21. The system of claim 4, wherein the processor is further configured to:
calculate the indicator to include only spatial derivatives of a secondary magnetic field H.

22. The system of claim 4, wherein the processor is further configured to:
calculate the indicator to include a sum of (i) spatial derivatives of the electromagnetic field measurements and (ii) the electromagnetic field measurements.

23. The system of claim 22, wherein the electromagnetic field measurements include only a secondary magnetic field H.

24. The system of claim 4, wherein the processor is further configured to:
calculate the indicator to include a sum or difference of only spatial derivatives of the electromagnetic field measurements.

25. The system of claim 4, wherein the processor is further configured to:
generate a primary electromagnetic field that induces the electromagnetic field measurements; and
generate a plot of the indicator based on which the location of the underground target is identified.

26. The system of claim 4, wherein the processor is further configured to:
calculate the indicator as a combination of electromagnetic fields and spatial derivatives of the electromagnetic fields to create an estimate for a second electromagnetic field;
receive measurements indicative of the second electromagnetic field; and
combine the estimated second electromagnetic field and the measured second electromagnetic field to improve the signal-to-noise ratio thereof.
